(19) United States
(12) Patent Application Publication
(10) Pub. No.: US 2024/0057803 A1
(43) Pub. Date: Feb. 22, 2024

(54) FRUIT AND VEGETABLE JUICER

(71) Applicant: GOLDEN PINEAPPLE GRINDER CO., LTD., NEW TAIPEI CITY (TW)

(72) Inventor: RONG-YUAN TSENG, NEW TAIPEI CITY (TW)

(21) Appl. No.: 18/261,047

(22) PCT Filed: Jan. 15, 2021
(86) PCT No.: PCT/CN2021/000010

§ 371 Date: Aug. 24, 2023

(51) Int. Cl. A47J 19/02

(52) U.S. Cl. CPC A47J 19/027

(57) ABSTRACT

A fruit and vegetable juicer contains: a first holder, a second holder, a filtration mesh, a juicing element connected with the filtration mesh and having multiple blades, and a cap. The first holder includes a transmission mechanism configured to drive the juicing element to rotate, the cap includes a feeding inlet configured to feed fruits and vegetables, such that the juicing element rotates to cut and grind fruits and vegetables. The multiple blades of the juicing element have multiple tips extending radially, some of the multiple tips are opposite to the other tips to form multiple forward blades and multiple reverse blades, such that the multiple forward blades and the multiple reverse blades rotate forward or reversely to remove residues and to cut and grind the fruits and vegetables simultaneously.

### TECHNICAL FIELD

The present disclosure relates to a fruit and vegetable juicer which is capable of removing residues from the juicing element to avoid a block and cutting fruits and vegetables simultaneously.

### BACKGROUND

Referring to FIG. 1, a conventional fruit and vegetable juicer contains a juicing element 8 on which multiple tip blades 81 are arranged radially so as to cut and crush fruits and vegetables when the juicing element 8 rotates, then liquids and residues are separated centrifugally. However, a gap is defined among the multiple tip blades 81 and the juicing element to accumulate the residues, thus blocking the multiple blades 81, stopping rotation of the juicing element 8, and damaging the transmission mechanism (such as a motor).

Thereby, the fruit and vegetable juicer is turned off to remove the juicing element 8 manually, then the juicing element 8 is washed to remove the residues, thus causing using problem.

The present invention has arisen to mitigate and/or obviate the afore-described disadvantages.

### SUMMARY

A primary aspect of the present invention is to provide a fruit and vegetable juicer which is capable of removing residues from the juicing element to avoid a block and cutting fruits and vegetables simultaneously, such that the residues of the fruits and vegetables (such as celery, ginger, burdock, and sugar cane etc.) are removed automatically, and the fruits and vegetables are cut and ground simultaneously, thus avoiding the block of the residues, poor cutting capacity, and failed operation.

To obtain above-mentioned aspect, a fruit and vegetable juicer provided by the present invention contains: a first holder, a second holder, a filtration mesh, a juicing element connected with the filtration mesh and having multiple blades, and a cap.

The first holder includes a transmission mechanism configured to drive the juicing element to rotate, the cap includes a feeding inlet configured to feed fruits and vegetables, such that the juicing element rotates to cut and grind fruits and vegetables.

The multiple blades of the juicing element have multiple tips extending radially, wherein some of the multiple tips are opposite to the other tips to form multiple forward blades and multiple reverse blades, such that the multiple forward blades and the multiple reverse blades rotate forward or reversely to remove residues and to cut and grind the fruits and vegetables simultaneously.

Preferably, the juicing element includes multiple first forward blades and multiple first reverse blades arranged thereon radially, and the multiple first forward blades are spaced from the multiple first reverse blades, wherein the juicing element further includes multiple second forward blades and multiple second reverse blades which are arranged on a center of the juicing element in a cross shape, wherein the multiple first and second forward blades and the multiple first and second reverse blades have multiple tips, and the multiple tips of the second forward blades are opposite to the multiple tips of the second reverse blades.

Preferably, the juicing element includes multiple first forward blades and multiple first reverse blades arranged thereon radially, and the multiple first forward blades are spaced from the multiple first reverse blades, wherein the multiple first and second forward blades and the multiple first and second reverse blades have multiple tips, and the multiple tips of the second forward blades are opposite to the multiple tips of the second reverse blades; the juicing element further includes a first cutter and a second cutter which are mounted on a center of the juicing element in a horizontal 1 shape, wherein the second cutter is opposite to the first cutter, the first cutter has a first cutting portion extending upward, and the second cutter has a second cutting portion extending upward.

Preferably, a center of the feeding inlet of the cap is eccentric with a center of the juicing element.

Preferably, the transmission mechanism is configured to drive the juicing element to rotate forward or reversely after being switched manually or automatically to rotate forward or reversely.

Preferably, the filtration mesh is closed without any bores.

Other objects and features will be in part apparent and in part pointed out hereinafter.

### BRIEF DESCRIPTION OF THE DRAWINGS

FIG. 1 is a side plane view of a juicing element of a conventional fruit and vegetable juicer.

FIG. 2 is a perspective view showing the exploded components of a fruit and vegetable juicer according to a preferred embodiment of the present invention.

FIG. 3 is a perspective view showing the assembly of the fruit and vegetable juicer according to the preferred embodiment of the present invention.

FIG. 4 is a perspective view showing the exploded components of a drive shaft of the fruit and vegetable juicer according to the preferred embodiment of the present invention.

FIG. 5 is a side plane view showing the assembly of a fitting portion of the fruit and vegetable juicer according to the preferred embodiment of the present invention.

FIG. 6 is a perspective view showing the assembly of multiple blades of the juicing element according to the preferred embodiment of the present invention.

FIG. 7 is a perspective view showing the operation of the tips of the blades according to the preferred embodiment of the present invention.

FIG. 8 is a perspective view showing the assembly of a juicing element according to another embodiment of the present invention.

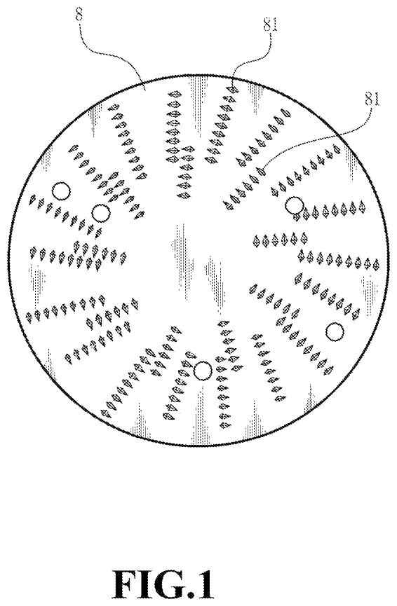

### DETAILED DESCRIPTION

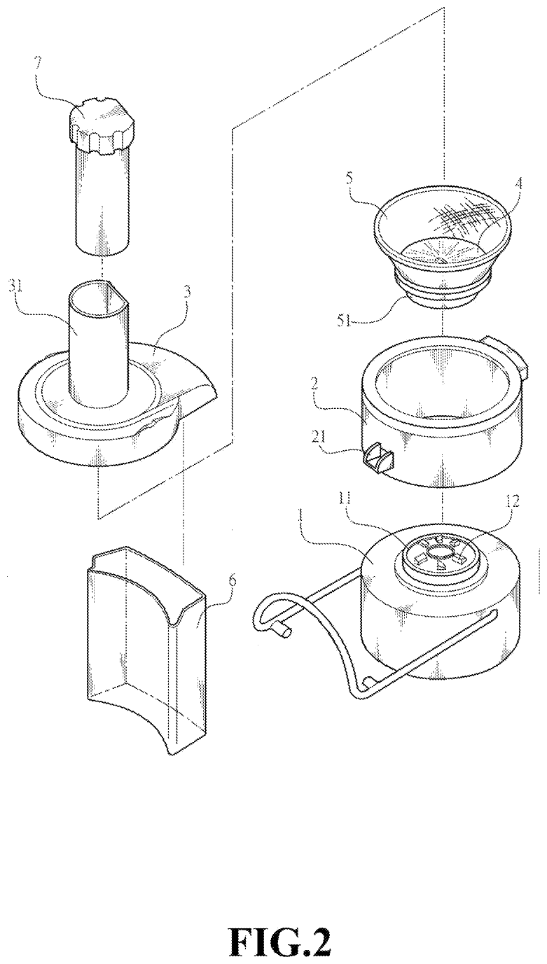

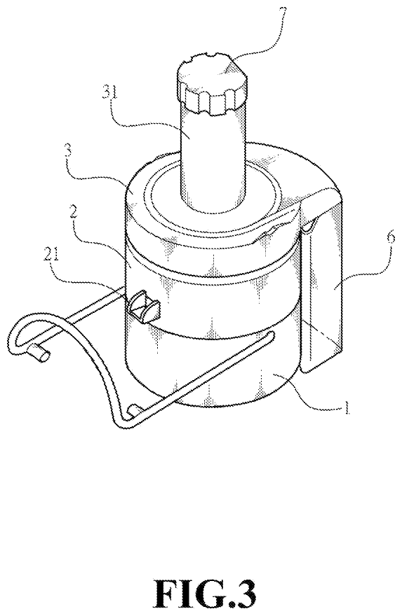

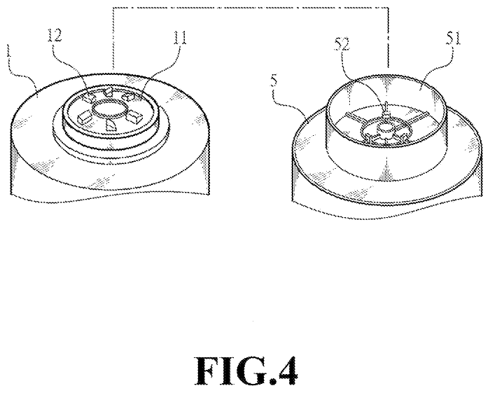

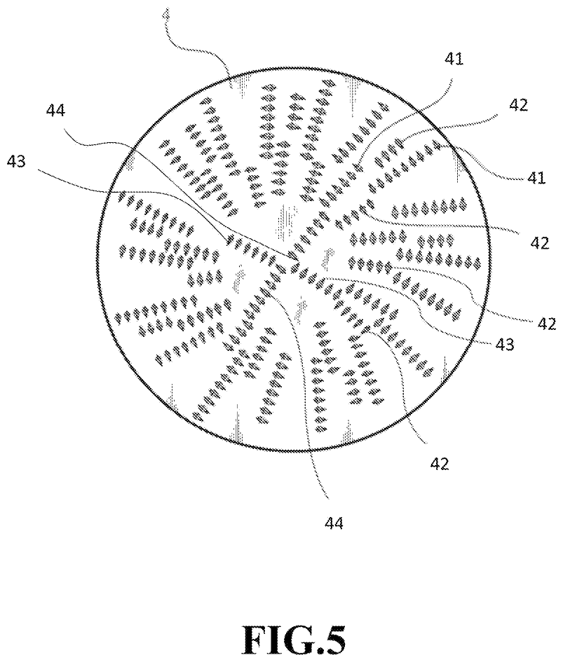

FIG. 2 is a perspective view showing the exploded components of a fruit and vegetable juicer according to a preferred embodiment of the present invention. FIG. 3 is a perspective view showing the assembly of the fruit and vegetable juicer according to the preferred embodiment of the present invention. FIG. 4 is a perspective view showing the exploded components of a drive shaft of the fruit and vegetable juicer according to the preferred embodiment of the present invention. FIG. 5 is a side plane view showing the assembly of a fitting portion of the fruit and vegetable juicer according to the preferred embodiment of the present invention.

The fruit and vegetable juicer comprises: a first holder 1, a second holder 2, and a cap 3, wherein the first holder 1 includes the drive shaft 11 driven by a transmission mechanism, such as a motor. The second holder 2 is fitted on the first holder 1 and accommodates a filtration mesh 5, wherein the filtration mesh 5 is screwed with a juicing element 4, and the filtration mesh 5 and the juicing element 4 are connected on the drive shaft 11; the second holder 2 includes a discharge outlet 21 defined on an outer wall thereof; wherein the cap 3 includes a feeding inlet 31 extending from a top thereof and configured to feed fruits and vegetables, and the cap 3 further includes a receiving blanket 6 mounted on a side of a bottom thereof.

The drive shaft 11 of the first holder 1 includes multiple protrusions 12 spacedly arranged thereon, the filtration mesh 5 includes the fitting portion 51 extending from a bottom thereof, and the filtration mesh 5 further includes multiple ribs 52 formed inside the fitting portion 51 and corresponding to the multiple protrusions 12. In this embodiment, the multiple protrusions 12 of the drive shaft 11 of the first holder 1 are tilted. The multiple ribs 52 of the fitting portion 51 of the filtration mesh 5 are arcuate so that the multiple ribs 52 are engaged with the multiple protrusions 12, after the fitting portion 51 of the filtration mesh 5 is fitted on the drive shaft 11 of the first holder 1, and the juicing disc 4 and the filtration mesh 5 rotatably grind the fruits and vegetables and centrifugally filter residues and liquids of the fruits and vegetables.

The juicing element 4 is a round plate on which multiple first forward blades 41 and multiple first reverse blades 42 are arranged radially, wherein the multiple first forward blades 41 are spaced from the multiple first reverse blades 42, and the round plate 4 includes multiple second forward blades 43 and multiple second reverse blades 44 which are arranged on a center of the round plate 4 in a cross shape or a horizontal 1 shape, wherein the multiple first and second forward blades 41, 43 and the multiple first and second reverse blades 42, 44 have multiple tips, and the multiple tips of the second forward blades 43 are opposite to the multiple tips of the second reverse blades 44. Furthermore, a center of the feeding inlet 31 of the cap 3 is eccentric with a center of the round plate 4.

In operation, the vegetables and fruits are fed into the feeding inlet 31, and a material puller 7 is configured to push the vegetables and fruits downward so that the multiple first and second forward blades 41, 43 and the multiple first and second reverse blades 42, 44 cut and grind the vegetables and fruits, after the round plate 4 and the filtration mesh 5 are driven by the drive shaft 11 to rotate at a high speed, then the filtration mesh 5 rotatably and centrifugally filter the residues and the liquids of the fruits and vegetables. When the round plate 4 rotates forward to cut and grind the fruits and vegetables, the multiple first and second forward blades 41, 43 cut and grind the fruits and vegetables, wherein the feeding inlet 31 of the fruit and vegetable juicer is located on the center of the round plate 4 so that the multiple second forward blades 43 cut and grind the fruits and vegetables at any blind angles, such that the fruits and vegetables (such as celery, ginger, burdock, and sugar cane etc.) are cut and ground by the multiple first and second forward blades 41, 43, but the residues accumulate and block gaps among the first and second forward blades 41, 43 and the round plate 4. The transmission mechanism (i.e. the motor) is controlled manually or automatically to rotate reversely so that the round plate 4 is driven to rotate reversely to remove the residues from the gaps among the multiple first forward blades 41 and the second forward blades 43, and the multiple first reverse blades 42 and the multiple second reverse blades 44 rotate reversely to cut and extract the juice from the fruits and vegetables, thus extracting the juice simultaneously by using the multiple first forward blades 41 and the second forward blades 43. Thereby, the fruit and vegetable juicer is capable of removing the residues and extracting the fruits and vegetables simultaneously.

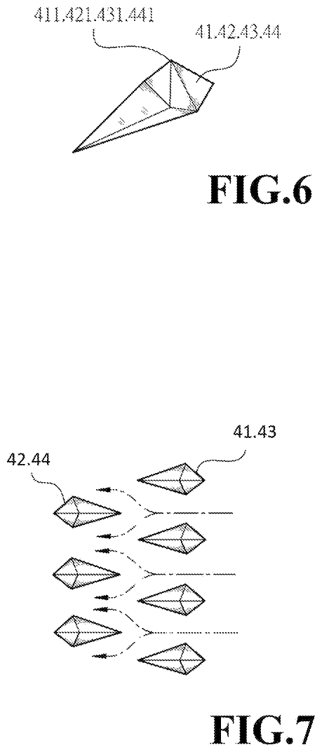

FIG. 6 is a perspective view showing the assembly of the multiple blades of the round plate according to the preferred embodiment of the present invention. Referring to FIGS. 6 and 4, a respective one first forward blade 41 has a first tip 411, a respective one first reverse blade 42 has a second tip 421, a respective one second forward blade 43 has a third tip 431, and a respective one second reverse blade 44 has a fourth tip 441, wherein the first, second, third, fourth tips 411, 421, 431, 441 extend upward from the round plate 4 and are configured to cut and grind the fruits and vegetables, when the round plate 4 rotates.

FIG. 7 is a perspective view showing the operation of the tips of the blades according to the preferred embodiment of the present invention. As shown in FIGS. 7 and 2-4, the first tip 411 of the respective one first forward blade 41 is opposite to the second tip 421 of the respective one first reverse blade 42. When the round plate 4 rotates forward to cut and grind the fruits and vegetables, the first tip 411 of the respective one first forward blade 41 and the second tip 431 of the respective one second forward blade 43 rotate forward to cut and grind the fruits and vegetables, such that the fruits and vegetables (such as the celery, the ginger, the burdock, and the sugar cane etc.) are cut and ground, but the residues accumulate and block the gaps among the respective one first forward blade 41, the first tip 411, the respective one second forward blade 43, and the second tip 431. The transmission mechanism (i.e. the motor) is controlled manually or automatically to drive the round plate 4 to rotate reversely, thus removing the residues from the gaps among the respective one first forward blade 41, the tip 411, the respective one second forward blade 43, and the second tip 431. In the meantime, the respective one first reverse blade 42 and the respective one second reverse blade 44 rotate reversely to cut and extract the juice from the fruits and vegetables by using the second tip 421 and the fourth tip 441.

Similarly, when the round plate 4 rotates reversely to cut and grind the fruits and vegetables, the second tip 421 of the respective one first reverse blade 42 and the fourth tip 441 of the respective one second reverse blade 44 rotate reversely to cut and grind the fruits and vegetables, such that the fruits and vegetables are cut and ground, but the residues accumulate and block the gaps among the second tip 421 of the respective one first reverse blade 42 and the fourth tip 441 of the respective one second reverse blade 44. The transmission mechanism (i.e. the motor) is controlled manually or automatically to drive the round plate 4 to rotate forward, and the respective one first reverse blade 42 and the respective one second reverse blade 44 rotate forward so that the residues remove from the gaps among the second tip 421 and the fourth tip 441, thus avoiding accumulation and block of the residues on the round plate 4. Similarly, when the round plate 4 rotates forward, the first tip 411 of the respective one first forward blade 41 and the third tip 431 of the respective one second forward blade 43 rotate forward to cut and extract the fruits and vegetables, thus removing the residues by using the second tip of the respective one first reverse blade 42 and cutting and extracting the fruits and vegetables by using the respective one forward blade 41. Thereby, the fruit and vegetable juicer of the present invention is capable of removing the residues and cutting and extracting the fruits and vegetables simultaneously.

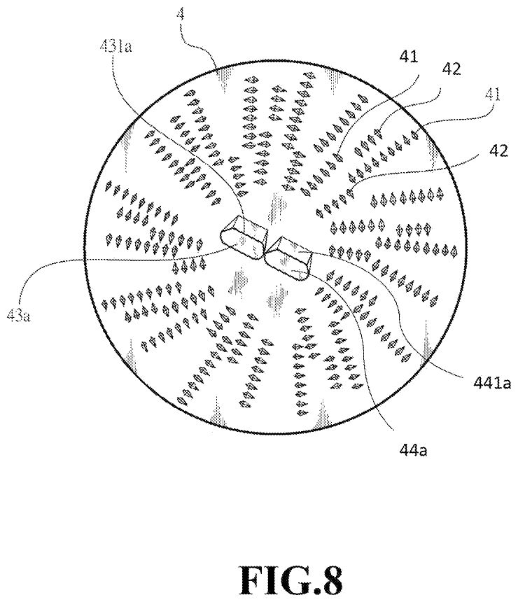

FIG. 8 is a perspective view showing the assembly of a juicing element according to another embodiment of the present invention. The round plate 4 includes a first cutter 43a and a second cutter 44a which are mounted on a center of the round plate 4, wherein the second cutter 44a is opposite to the first cutter 43a, the first cutter 43a has a first cutting portion 431a extending upward, and the second cutter 44a has a second cutting portion 441a extending upward.

Accordingly, the fruit and vegetable juicer comprises the first holder, the second holder, the motor, the multiple first and second forward blades, the multiple first and second reverse blades, and the round plate to remove the residues and to cut and extract the fruits and vegetables simultaneously.

Having described the invention in detail, it will be apparent that modifications and variations are possible without departing from the scope of the invention defined in the appended claims.

When introducing elements of the present invention or the preferred embodiments thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A fruit and vegetable juicer comprising: a first holder, a second holder, a filtration mesh, a juicing element connected with the filtration mesh and having multiple blades, and a cap;
the first holder including a transmission mechanism configured to drive the juicing element to rotate, the cap including a feeding inlet configured to feed fruits and vegetables, such that the juicing element rotates to cut and grind fruits and vegetables;
wherein the multiple blades of the juicing element have multiple tips extending radially, wherein some of the multiple tips are opposite to the other tips to form multiple forward blades and multiple reverse blades, such that the multiple forward blades and the multiple reverse blades rotate forward or reversely to remove residues and to cut and grind the fruits and vegetables simultaneously.

2. The fruit and vegetable juicer as claimed in claim 1, wherein the juicing element includes multiple first forward blades and multiple first reverse blades arranged thereon radially, and the multiple first forward blades are spaced from the multiple first reverse blades, wherein the juicing element further includes multiple second forward blades and multiple second reverse blades which are arranged on a center of the juicing element in a cross shape, wherein the multiple first and second forward blades and the multiple first and second reverse blades have multiple tips, and the multiple tips of the second forward blades are opposite to the multiple tips of the second reverse blades.

3. The fruit and vegetable juicer as claimed in claim 1, wherein the juicing element includes multiple first forward blades and multiple first reverse blades arranged thereon radially, and the multiple first forward blades are spaced from the multiple first reverse blades, wherein the multiple first and second forward blades and the multiple first and second reverse blades have multiple tips, and the multiple tips of the second forward blades are opposite to the multiple tips of the second reverse blades; the juicing element further includes a first cutter and a second cutter which are mounted on a center of the juicing element in a horizontal 1 shape, wherein the second cutter is opposite to the first cutter, the first cutter has a first cutting portion extending upward, and the second cutter has a second cutting portion extending upward.

4. The fruit and vegetable juicer as claimed in claim 1, wherein a center of the feeding inlet of the cap is eccentric with a center of the juicing element.

5. The fruit and vegetable juicer as claimed in claim 1, wherein the transmission mechanism is configured to drive the juicing element to rotate forward or reversely after being switched manually or automatically to rotate forward or reversely.

6. The fruit and vegetable juicer as claimed in claim 1, wherein the filtration mesh is closed without any bores.
